(19) United States
(12) Patent Application Publication
(10) Pub. No.: US 2006/0241528 A1
(43) Pub. Date: Oct. 26, 2006

(54) System and method for a low profile vibrating plate

(76) Inventor: Roger J. Talish, Hillsborough, NJ (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/369,467

(22) Filed: Mar. 7, 2006

Related U.S. Application Data
(60) Provisional application No. 60/659,216, filed on Mar. 7, 2005.

(51) Int. Cl. A61H 1/00

(52) U.S. Cl. 601/2

(57) ABSTRACT

A medical treatment system and method are provided for the treatment of tissue ailments, including weakened bone structures caused by fractures, osteoporosis, or other bone related ailments, and orthostatic hypotension, using a vibrating plate. The system and method use magnetic fields to provide vertical vibrational motion to a platform, thus allowing the system to have a lower profile.

### PRIORITY

This patent application claims priority to a U.S. provisional patent application filed on Mar. 7, 2005, titled “System and Method for a Low Profile Vibrating Plate” and assigned U.S. Provisional Application Ser. No. 60/659,216; the entire contents of which are incorporated herein by reference.

### BACKGROUND

1. Technical Field

This disclosure relates to a medical treatment procedure and apparatus for performing the same. More particularly, the disclosure relates to a non-invasive method and apparatus for treating ailments related to weak bone structure or orthostatic hypotension.

2. Description of the Prior Art

Weakened bone structure and improperly healed or slowly healing bone fractures may result in reduced quality of life. Quality of life may be improved for patients with bone fractures by ensuring rapid healing and by inhibiting the loss of bone mineral content (bone mass), and therefore bone strength, associated with fractures. Metabolic bone diseases, such as osteoporosis, also reduce the quality of life.

Osteoporosis is a pernicious disorder usually, but not exclusively, afflicting elderly women. The osteoporotic state can also be manifested by those who are confined to bed and even to astronauts who are subjected to prolonged weightlessness. Osteoporosis occurs through a decrease in bone mass, which makes the afflicted bones more fragile and more susceptible to breakage.

The reduction in bone mass from osteoporosis results when destruction outpaces bone formation. The balance between destruction and formation is affected by hormones, calcium intake, vitamin D and its metabolites, weight, smoking, alcohol consumption, age, genetic determinants and especially exercise or other methods of dynamically loading the bone tissue as well as many other factors. Considering the vast array of factors which can compromise the healing process, any form of stimulation that can accelerate, augment and/or ensure the healing process are greatly needed.

Osteoporosis is not easily determined in its early phases as physical deformity is not yet evident. Because osteoporosis develops progressively, early diagnosis and appropriate treatment may avoid a serious condition. Appropriate diet and exercise can be used in early years to prevent the damaging effects of osteoporosis later in life. Methods for maintaining or promoting bone growth are described in numerous patents. For example, McLeod and Rubin, U.S. Pat. Nos. 5,103,806, 5,191,880, 5,273,028 and 5,376,065, all incorporated herein by reference, collectively describe means and methods for promoting bone growth and preventing bone loss. The method described in the above referenced patents relates to a mechanical vibrational loading of bones to promote growth in a non-invasive procedure.

Mechanical loading on bone tissue at strains of between about 0.5 to about 500 microstrain and induced within a predetermined frequency range can prevent bone loss and enhance new bone formation. Such mechanical bone loading of tissue may be introduced by various system, including vibrating floor plates and chairs, electrical stimulation of muscles, isometric exercises, modulated ultrasound or transducers attached to the skin or external fixation devices to focus energy to the fracture site.

Hypotension is manifested as abnormally low blood pressure. Orthostatic hypotension is a condition caused by extended periods of quiet standing or sitting or by sudden changes of position from sitting or lying to a sitting or standing position. The effects of orthostatic hypotension are mainly age-dependent and may include high rate of bone loss and muscle degeneration. These effects are primarily attributed to decreases in blood and fluid flow in the lower extremities when the body is in static upright posture for a prolonged period of time.

It has been shown that the ability of the skeletal muscle pump to contribute to sustaining blood flow varies considerably as a function of age and/or physical status. For example, the data on postmenopausal women indicate that there are sub-populations of women, which do not adapt well to orthostasis. It has been demonstrated that declining systolic pressure, in the absence of any corresponding significant rise in diastolic pressure and/or pulse rate, indicates the potential for significantly decreased blood flow to the lower extremities for many postmenopausal women while in an upright position for a prolonged period of time. Such a response is consistent with high rates of bone loss and muscle degeneration.

Current methods of treating orthostatic hypotension include having the individual wear elastic stockings. The individual is generally prescribed elastic stockings if his blood pressure drops more than 20 mm/Hg while in an upright posture, or the individual manifests obvious signs of orthostatic hypotension, e.g., fainting.

### SUMMARY

The present disclosure provides a low profile vibrating plate system for providing a medical treatment of ailments related to bone density loss and/or orthostatic hypotension. The disclosed system includes a low profile base having a cavity, a platform, having an upper portion and a lower portion, dimensioned to fit within the cavity. The platform is free moving within the cavity. The platform's upper portion provides a rigid base upon which a patient is to stand.

The disclosed system further includes two sets of magnetic field generating devices. A first set of one or more magnetic field generating devices is affixed to the platform's lower portion, while a second set of one or more magnetic field generating devices is affixed to a lower surface of the cavity. The second set is aligned with the first set for at least a portion of time and for at least a portion of time has polarity equal to the polarity of the first set. A controller in electrical communication with the second set of one or more magnetic field generating devices is configured for control of the polarity and magnetic field intensity of the second set of one or more magnetic field generating devices.

Additionally, the present disclosure provides a method for using a low profile vibrating plate as a medical treatment of ailments related to bone density loss and/or orthostatic hypotension. The disclosed method provides a low profile base having a cavity and a platform dimensioned to fit within the cavity in a free moving manner. The platform provides a lower portion and an upper portion, wherein the upper portion provides a rigid base upon which a patient is to stand.

The disclosed method, additionally, provides for generating a first magnetic field using a first set of one or more magnetic field generating devices affixed to the platform's lower portion and generating a second magnetic field using a second set of one or more magnetic field generating devices affixed to a lower surface of the cavity, the second set is aligned with the first set for at least a portion of time and for at least a portion of time has a polarity equal to the polarity of the first set. The method further performs the step of controlling the second generated magnetic field by adjustment of polarity and magnetic field intensity of the second set of one or more magnetic field generating devices.

The use of magnetic field generating devices in the embodiments of the present disclosure provides several key benefits. Magnetic field generating devices allow for a more compact form-factor for the vibrating plate, which allows for increased portability. Additionally, with most mechanical parts eliminated, the vibrating plate of the present disclosure has increased reliability and lower power consumption.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic view of an embodiment of a low profile vibrating plate in accordance with the present disclosure;

FIG. 2 is a schematic view of an alternate embodiment of a low profile vibrating plate in accordance with the present disclosure;

FIG. 3 is a schematic view of another alternate embodiment of a low profile vibrating plate in accordance with the present disclosure;

FIG. 4 is a flowchart of the steps performed by an embodiment of a low profile vibrating plate in accordance with the present disclosure; and

FIG. 5 is a schematic view of another alternate embodiment of a low profile vibrating plate in accordance with the present disclosure.

### DESCRIPTION OF THE PREFERRED EMBODIMENTS

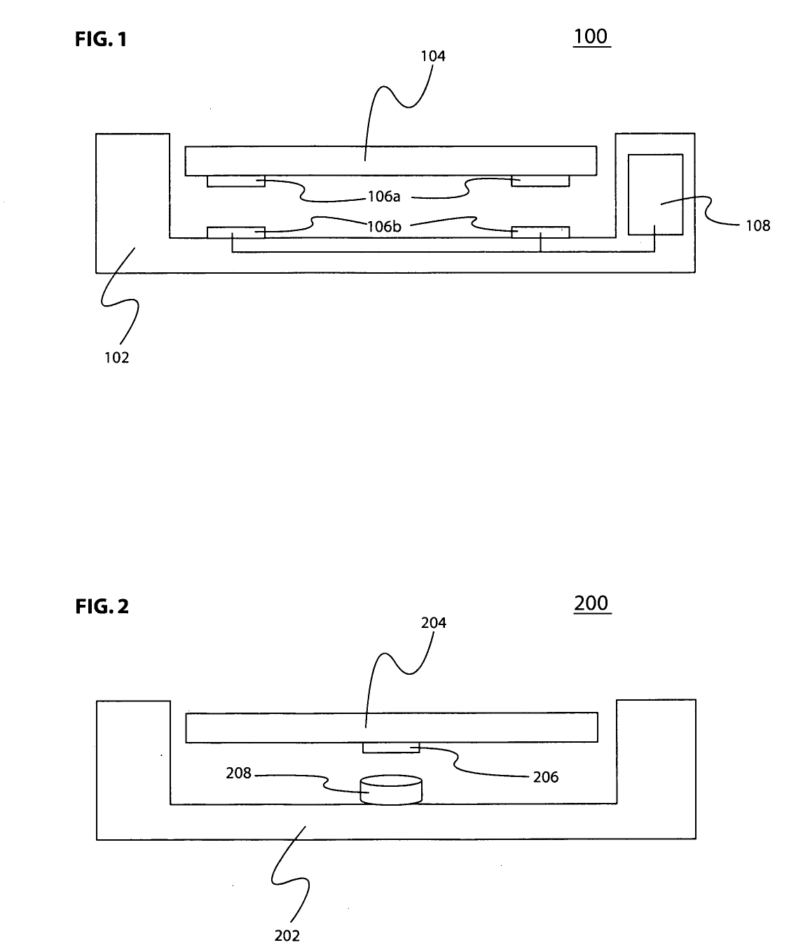

Referring to FIG. 1, an embodiment of the present disclosure provides a low profile vibrating plate system 100 for use in medial treatments. The system 100 includes a low profile base 102 and a platform 104. The platform 104 rests within a cavity formed on the top surface of the low profile base 102. Two sets of magnets 106a and 106b are positioned, one set 106a, on the underside of the platform and, a second set 106b, on the lower surface of the cavity, such that the magnets 106a on the platform 104 and the magnets 106b on the low platform base 102 are paired. Each paired magnet 106a and 106b are set with equivalent polarities facing each other, thus providing a repellant force between the pair and consequently, causing the platform 104 to levitate above the low profile base 102. The second set of magnets 106b has adjustable magnetic properties (e.g., polarity, magnetic field intensity) controlled by a processor 108 in electrical communication with the second set of magnets 106b. The second set of magnets 106b, can be a set of electromagnets, coils, or other dynamic magnetic field generating devices. The set of magnets 106a on the platform are preferably static magnetic field generating devices, such as permanent Ferro-magnets, but may also be electromagnets, coils, or dynamic magnetic field generating devices.

By varying the field intensity and/or alternating the polarity of the base magnets 106b a vertical vibration of the platform 104 can be induced. The vibrational frequency is determined by the rate of change of the magnetic properties, while the amplitude of the vibration is determined by the magnetic field intensity. Additionally, the magnetic field intensity may be increased or decreased as needed, depending on a patient's weight, to properly position and vibrate the platform 104.

To limit travel of the platform 104, one or more stops may be affixed to the low profile base 102 at the upper limit of the platform's 104 travel, thus preventing the platform 104 from separating from the low profile base 102. The stops may be bumpers in this case, or alternatively, the stops may be a cable, spring or elastic band connected to the underside of the platform 104 and the bottom of the cavity of the low profile base 102.

Referring to FIG. 2, an alternate embodiment of the present disclosure is illustrated. The system 200 has a supporting low profile base 202 with a central cavity and a platform 204, which fits within the cavity. A magnetic field generating device 206 is affixed and positioned centrally on the underside of the platform 204. The magnetic field generating device 206 is preferably a permanent Ferro-magnetic device. Aligned directly below the magnetic field generating device 206 is a single dynamic magnetic field generating device 208, which is controllable as described above for the embodiment in FIG. 1.

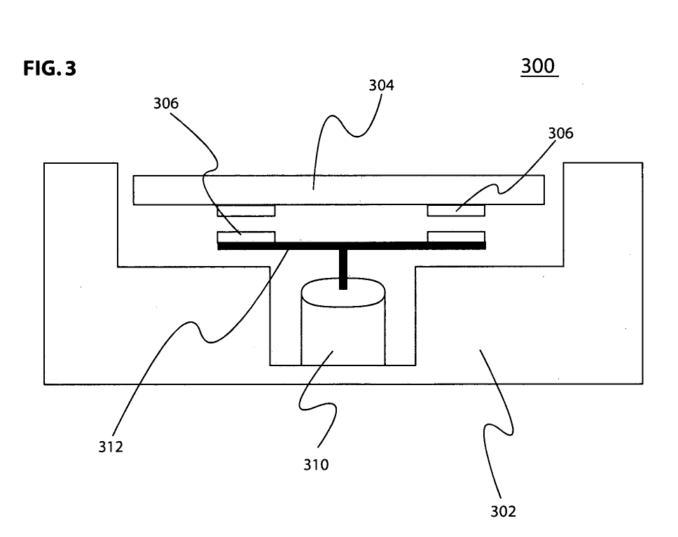

Referring to FIG. 3, yet another embodiment of the present disclosure is illustrated. The system 300 imparts vibrational motion to the platform 304 via a varying magnetic field produced by a set of magnets 306b positioned on either end of a horizontal arm 312 attached to a motor 310. The motor 310 is located within a central cavity of the low profile base 302.

As the horizontal arm 312 rotates, the magnets 306b align and unalign periodically with magnets 306a attached to the underside of the platform 304. The magnets 306a and 306b are set to provide repulsive force against each other, so that, upon alignment of the magnets 306a and 306b, the platform 304 is levitated upward and upon unalignment, the repulsive force is removed allowing the platform 304 to drop downward. The speed at which the motor 310 rotates the magnets 306b directly determines the vibrational frequency of the plate, thus by varying the rotational speed of the motor 310, the frequency is adjusted to provide optimal therapeutic benefit to the patient.

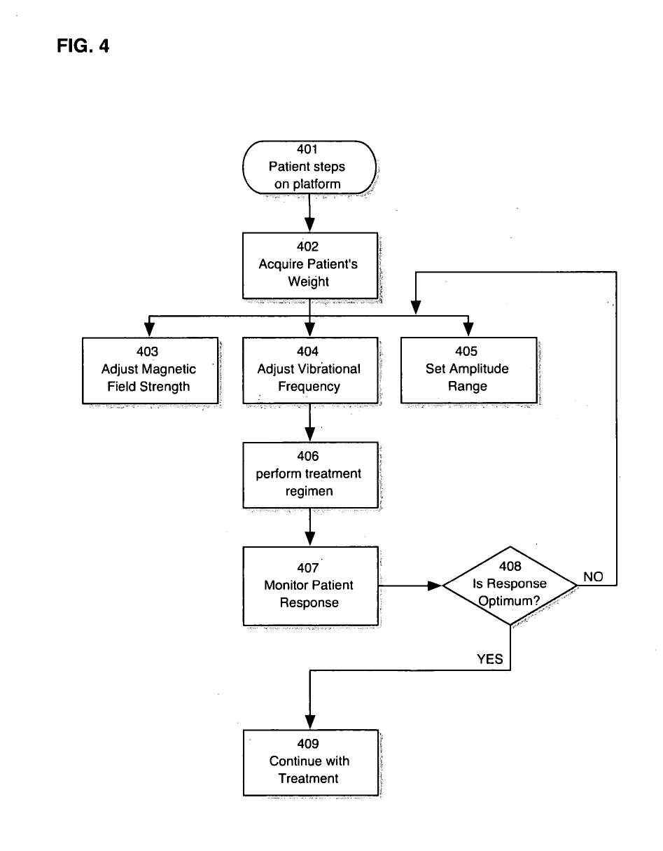

The flowchart of FIG. 4 illustrates the steps performed by an embodiment of the present disclosure. Beginning with step 401, a patient is positioned on the platform 102. In step 402, the patient's weight is measured and relayed to the controller 108. Any of several well-known methods for measuring weight may be incorporated within the system 100. Alternatively, the weight may be measured prior to step 401 and the value entered into the controller manually by the system operator. In Step 403, the weight measurement is used for determining the proper magnetic field strength by the controller 108. The treatment parameters are set in step 404, where the desired vibrational frequency is relayed to the controller 108, and 405, where the amplitude of the vibration treatment is entered. The treatment regimen is administered in step 406 and patient response is monitored and in step 407. The monitor responses are further evaluated in step 408. If the patient is responding appropriately to the treatment, then the treatment continues in step 409 for the duration of the treatment session. However, if the patient is experiencing difficulties or other inappropriate responses are detected, then the treatment session is stopped and the treatment parameters are adjusted in steps 404 and 405. After readjusting the parameters, a new round of treatment is initiated, as previously described, continuing on from step 406.

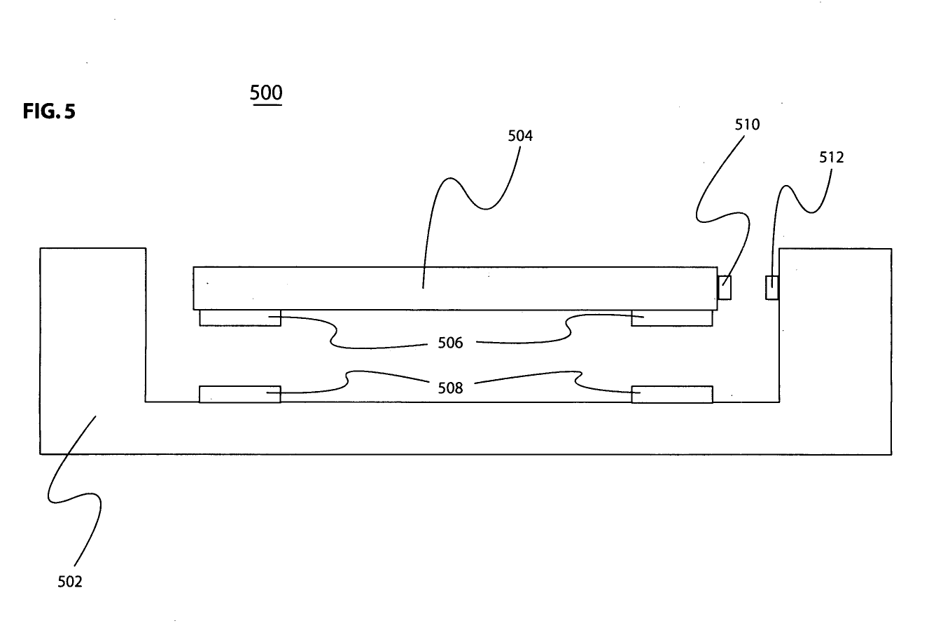

Referring to FIG. 5, yet another embodiment of the present disclosure is illustrated. As in the embodiment of FIG. 1, the system 500 has a supporting low profile base 502 with a central cavity and a platform 504, which fits within the cavity. A first set of magnetic field generating devices 506 is affixed and positioned on the underside of the platform 504. The first set of magnetic field generating devices 506 is preferably made of permanent Ferro-magnetic materials. Aligned directly below the first set of magnetic field generating devices 506 is a second set of magnetic field generating devices 508, which is controllable as described above for the embodiment in FIG. 1.

Additionally, a third set of magnetic field generating devices 510 is positioned along at least one side of the platform 504. As with the first set of magnetic field generating devices 506, the third set of magnetic field generating devices 510 is preferably made from permanent Ferro-magnetic materials. A fourth set of magnetic field generating devices 512 is located and aligned opposite the third set of magnetic field generating devices 510 on a side wall of the cavity of the low profile base 502. The fourth set of magnetic field generating devices 512 is controllable in the same manner as described for the second set of magnetic field generating devices 508, such that a controlled horizontal vibration is imparted on the platform 504. By alternating the magnetic polarity of the fourth set of magnetic field generating devices 512, a horizontal vibration of the platform 504 is induced. Additional magnet sets may be placed on a perpendicular side of the platform 504 and cavity wall to induce a third dimension of vibration of the platform 504.

The described embodiments of the present disclosure are intended to be illustrative rather than restrictive, and are not intended to represent every embodiment of the present disclosure. Various modifications and variations can be made without departing from the spirit or scope of the present disclosure as set forth in the following claims both literally and in equivalents recognized in law.

What is claimed is:

1. A vibrating plate system, comprising:
a low profile base;
a platform dimensioned to fit in juxtaposed alignment with said base, said platform having an upper portion and a lower portion;
a first set of one or more magnetic field generating devices affixed to said lower portion of said platform;
a second set of one or more magnetic field generating devices affixed to said base, said second set being aligned with said first set for at least a portion of time and for at least a portion of time has a polarity equal to the polarity of said first set; and
a controller in electrical communication with at least one of said first and second set of one or more magnetic field generating devices and configured for control of polarity and magnetic field intensity of said first and second set of one or more magnetic field generating devices.

2. The system of claim 1, wherein a cavity dimensioned to accommodate said platform is located on a surface of said base.

3. The system of claim 1, further comprising:
a third set of one or more magnetic field generating devices affixed to a side portion of said platform; and
a fourth set of one or more magnetic field generating devices affixed to a side of said base, said fourth set being aligned with said third set for at least a portion of time and for at least a portion of time has a polarity equal to the polarity of said third set.

4. The system of claim 1, wherein said first and second sets of magnetic field generating devices may be any combination of static ferromagnetic objects and electromagnets.

5. The system of claim 1, wherein said first set of magnetic field generating devices generates a static magnetic field and said second set of magnetic field generating devices generates a dynamic magnetic field, having any combination of alternating polarity and varying magnetic field intensity.

6. The system of claim 1, wherein said second set of magnetic field generating devices are mounted on a rotating member attached to an electric motor, said generated magnetic field varies with the instantaneous position of said individual devices of said second set of magnetic field generating devices.

7. The system of claim 1, further comprising of a stop configured to restrict vertical travel of said platform within a predefined displacement range.

8. The system of claim 7, wherein said stop is a spring anchored to said platform and said low profile base.

9. The system of claim 7, wherein said stop is a set of one or more bumpers affixed to said low profile base and positioned above and or below said platform.

10. The system of claim 1, wherein said platform vibrates vertically with a frequency of between 0 Hz and 10 KHz.

11. The system of claim 10, wherein said frequency is 30 Hz.

12. A method for providing a medical treatment for tissue related ailments using a low profile vibrating plate said method comprising the steps of:
providing a low profile base;
providing a platform dimensioned to fit in juxtaposed alignment with said base, said platform having an upper portion and a lower portion;
generating a first magnetic field using a first set of one or more magnetic field generating devices affixed to said lower portion of said platform;
generating a second magnetic field using a second set of one or more magnetic field generating devices affixed to said base, said second set being aligned with said first set for at least a portion of time and for at least a portion of time have polarity equal to the polarity of said first set; and
controlling at least one of said first and second generated magnetic field by adjustment of polarity and magnetic field intensity of said first and second set of one or more magnetic field generating devices.

13. The method of claim 12, wherein a cavity dimension to accommodate said platform is located on a surface of said base.

14. The system of claim 12, further comprising:
generating a third magnetic field using a third set of one or more magnetic field generating devices affixed to a side portion of said platform; and
generating a fourth magnetic field using a fourth set of one or more magnetic field generating devices affixed to a side of said base, said fourth set being aligned with said third set for at least a portion of time and for at least a portion of time has a polarity equal to the polarity of said third set.

15. The method of claim 12, wherein said first and second sets of magnetic field generating devices may be any combination of static ferromagnetic objects and electromagnets.

16. The method of claim 12, wherein said first magnetic field is a static magnetic field and said second magnetic field is a dynamic magnetic field, having any combination of alternating polarity and varying magnetic field intensity.

17. The method of claim 12, further comprising the step of restricting vertical travel of said platform within a predefined displacement range.

18. The method of claim 17, wherein said restriction is provided by a spring anchored to said platform and said low profile base.

19. The method of claim 17, wherein said restriction is provided by a set of one or more bumpers affixed to said low profile base and positioned above and or below said platform.

20. The method of claim 12, wherein said platform vibrates vertically with a frequency of between 0 Hz and 10 KHz.

21. The method of claim 20, wherein said frequency is 30 Hz.

22. A system for providing a medical treatment for tissue related ailments using a low profile vibrating plate said method comprising:
a low profile base;
a platform dimensioned to fit in juxtaposed alignment with said base, said platform having an upper portion and a lower portion;
means for generating a first magnetic field using a first set of one or more magnetic field generating devices affixed to said lower portion of said platform;
means for generating a second magnetic field using a second set of one or more magnetic field generating devices affixed to said base, said second set being aligned with said first set for at least a portion of time and for at least a portion of time have polarity equal to the polarity of said first set; and
means for controlling at least one of said first and second generated magnetic field by adjustment of polarity and magnetic field intensity of said first and second set of one or more magnetic field generating devices.

23. The system of claim 22, wherein a cavity dimensioned to accommodate said platform is located on a surface of said base.

24. The system of claim 22, further comprising:
means for generating a third magnetic field using a third set of one or more magnetic field generating devices affixed to a side portion of said platform; and
means for generating a fourth magnetic field using a fourth set of one or more magnetic field generating devices affixed to a side of said base, said fourth set being aligned with said third set for at least a portion of time and for at least a portion of time has a polarity equal to the polarity of said third set.
